(19) United States
(12) Patent Application Publication
(10) Pub. No.: US 2003/0081519 A1
(43) Pub. Date: May 1, 2003

(54) Optical disk player

(76) Inventor: Takashi Harada, Nagano (JP)

Correspondence Address: BIRCH STEWART KOLASCH & BIRCH, PO BOX 747, FALLS CHURCH, VA, 22040-0747, US

(21) Appl. No.: 10/265,267

(22) Filed: Oct. 7, 2002

(30) Foreign Application Priority Data
Oct. 26, 2001 (JP) 2001-328630
Jul. 11, 2002 (JP) 2002-202928

(51) Int. Cl. G11B 7/00

(52) U.S. Cl. 369/53.3

(57) ABSTRACT

The optical disk player is capable of showing the change of the data writing velocity and/or the changed writing velocity to a user. The optical disk player comprises: means for indicating a change of data writing velocity. With this structure, the user can know the fact of changing the data writing velocity without executing any operation.

### BACKGROUND OF THE INVENTION

The present invention relates to an optical disk player capable of writing data on an optical disk, e.g., CD-R (Compact Disk-Recordable), CD-RW (Compact Disk-Rewritable).

Optical disk players have been used so as to write data on optical disks, e.g., CD-R, CD-RW.

Rotational speed of an optical disk while writing data is controlled on the basis of writing velocity, e.g., liner velocity, angular velocity.

In a conventional optical disk player, for example, the rotational speed of an optical disk is controlled to maintain liner velocity for writing data on an optical disk. By maintaining the liner velocity, the data can be written with fixed pit density. This writing manner is called a CLV (Constant Liner Velocity) manner.

In the CLV manner, the liner velocity is maintained, so the rotational speed of the optical disk is made faster while data are written in an inner part of the disk, and the rotational speed of the optical disk is made slower while data are written in an outer part of the disk.

These days, high speed writing is required. To accelerate the writing speed by the CLV manner, the rotational speed of the optical disk is merely accelerated, so that the rotational speed is too fast to write data in the inner part of the optical disk. Namely, data cannot be securely written in the inner part of the optical disk.

This problem of the CLV manner was solved by a zone CLV manner, in which data can be written in the inner part of the optical disk without over-accelerating the rotational speed of the optical disk and total writing time can be shortened.

In the zone CLV manner, data are written in the inner part of the optical disk with fixed low liner velocity, so the rotational speed for writing data in the inner part is equal to that of the CLV manner. The liner velocity is accelerated, by stages, with moving a data writing part toward an outer edge of the optical disk.

The zone CLV will be explained with reference to FIG. 4.

In the example shown in FIG. 4, data are written in an inner part of an optical disk 10 with 16× liner velocity; after the laps of prescribed time, data are written in an intermediate part thereof with 20× liner velocity; and after the laps of another prescribed time, data are written in an outer part thereof with 24× liner velocity.

By employing the zone CLV manner, the rotational speed for writing data in the inner part of the disk 10 is equal to a proper speed of the CLV manner, so total writing time can be shortened without writing errors in the inner part.

A perspective view of a conventional disk player is shown in FIG. 5.

An indicator 54 for indicating a state of reading data or writing data is provided in a front panel 51 of the optical disk player 50.

The indicator 54 includes LEDs (not shown). The state of reading data or writing data is indicated by turning on or blinking the LEDs. A user can know the state by watching the indicator 54.

Details of the indicator 54 will be explained.

The indicator 54 includes a green color LED and an orange color LED. The LEDs are selectively turned on or blinked to indicate the state. When both LEDs are turned on, the indicator 54 emits yellow light.

For example, in the state of writing data, the indicator 54 blinks with orange-colored light; in the state of reading data, the indicator 54 continuously emits yellow-colored light. Note that, in a state of accessing to the optical disk, the indicator 54 continuously emits green-colored light.

In the conventional disk player 50, a cycle time of blinking the orange-colored light is changed when the data writing velocity is changed. In the case of writing data with the maximum data writing velocity, the indicator 54 blinks with a prescribed cycle time; in the case of writing data with data writing velocity other than the maximum velocity, the indicator 54 merely blinks with a cycle time longer than said prescribed time.

In the case of writing data on a scratched or flexed disk, even if the data writing velocity is previously determined by a user, data cannot be written with the predetermined velocity. The optical disk player automatically changes to the writing velocity slower than the predetermined velocity. In this case, it takes a long time, which is longer than estimated time, to write data, so that the user cannot know actual data writing velocity.

In the zone CLV manner, the writing liner velocity is accelerated by stages until reaching an outer part of the disk. In a conventional disk player employing the zone CLV manner, the indicator 54 indicates the maximum writing liner velocity only. In spite of gradually changing the writing velocity, the user cannot know current actual data writing velocity.

Especially, in the state that a host computer controls the conventional optical disk player to write data on an optical disk, current actual writing velocity can be known through the host computer only. Namely, the user cannot easily know the current actual writing velocity.

### SUMMARY OF THE INVENTION

An object of the present invention is to provide an optical disk player capable of showing the change of the data writing velocity and/or the changed writing velocity to a user.

To achieve the object, the present invention has following structures.

The optical disk player of the present invention comprises: means for indicating a change of data writing velocity. With this structure, the user can know the fact of changing the data writing velocity without executing any operation.

In the optical disk player, the indicating means may include light emitting means which indicates the change of data writing velocity by changing a cycle time of blinking light. With this simple structure, the user can know the fact of changing the data writing velocity without executing any operation.

Another optical disk player, in which liner velocity of writing data is accelerated, by stages, toward an outer edge of an optical disk, comprises: means for indicating a change of the liner velocity. With this structure, in the case of automatically changing the writing liner velocity by the zone CLV manner, the user can know when the liner velocity is changed.

In the optical disk player, the indicating means may include light emitting means which indicates the change of the liner velocity by changing a cycle time of blinking light. With this simple structure, the user can know the fact of changing the data writing velocity without executing any operation.

The optical disk player may further comprise: means for indicating the changed liner velocity. With this structure, the user can easily know current actual liner velocity.

In the optical disk player, the indicating means may include light emitting means which indicates the changed liner velocity by changing a cycle time of blinking light. With this simple structure, the user can easily know current actual liner velocity.

### BRIEF DESCRIPTION OF THE DRAWINGS

Embodiments of the present invention will now be described by way of examples and with reference to the accompanying drawings, in which:

FIG. 1 is a block diagram of an optical disk player of the present invention;

FIG. 2 is an explanation view showing a relationship between data writing velocity and blinking cycle time of an indicator under the zone CLV manner;

FIG. 3 is an explanation view showing a relationship between the data writing velocity and the blinking cycle time of the indicator, wherein the data writing velocity is made slower;

FIG. 4 is an explanation view showing the zone CLV manner; and

FIG. 5 is a perspective view of the conventional optical disk player.

### DETAILED DESCRIPTION OF THE EMBODIMENTS

Preferred embodiments of the present invention will now be described in detail with reference to the accompanying drawings.

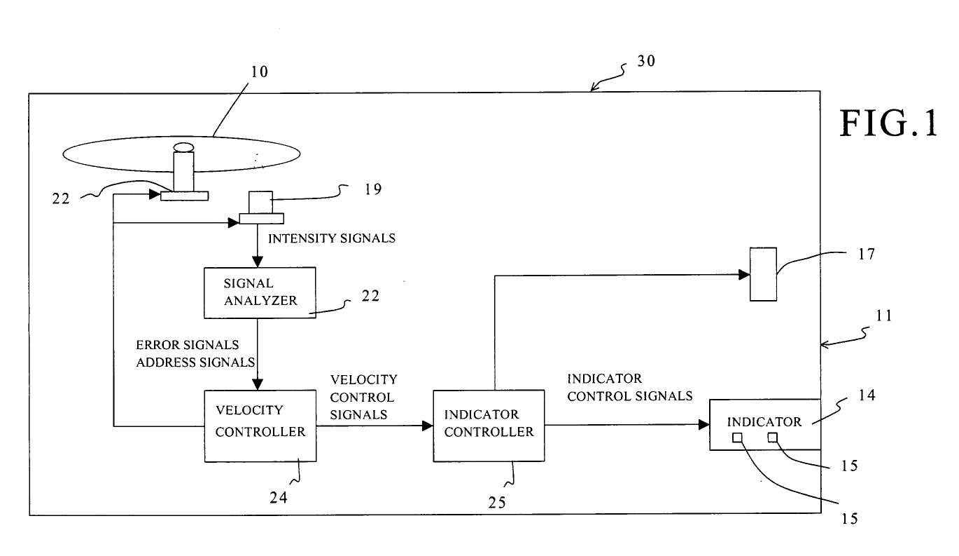

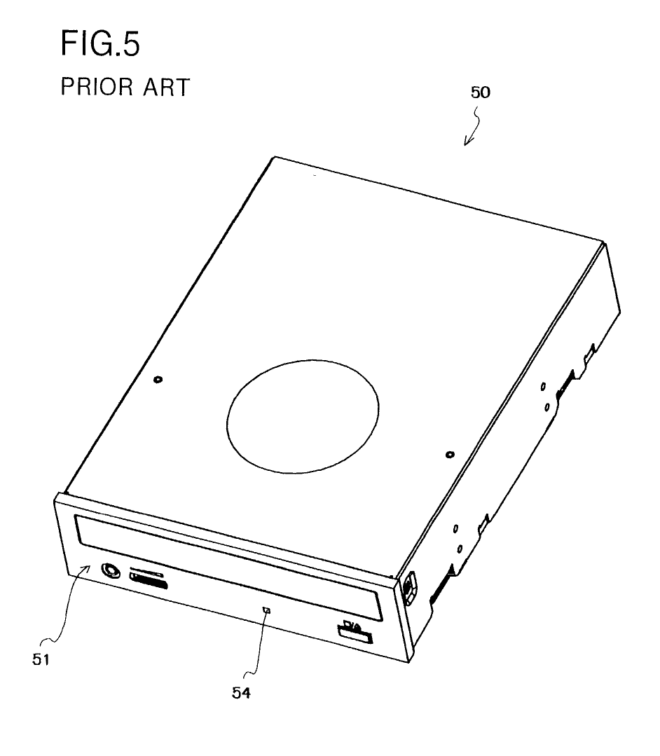

FIG. 1 is a block diagram of the optical disk player 30 of the present embodiment. Note that, an external shape of the optical disk player 30 is similar to that of the conventional disk player 50 (see FIG. 5), and an indicator 14 is provided instead of the indicator 54 (see FIG. 5). Further, the indicator 14 also includes the green color LED 15 and the orange color LED 15. The LEDs 15 are selectively turned on or blinked to indicate the state. For example, in the state of writing data, the indicator 14 blinks with orange-colored light; in the state of reading data, the indicator 14 continuously emits yellow-colored light; in the state of accessing to the optical disk, the indicator 14 continuously emits green-colored light.

The optical disk player 30 has an optical pick-up 19 including a laser diode (not shown), which irradiates a laser beam to an optical disk 10, and a photo detector (not shown), which receives a reflected laser beam reflected from the disk 10.

A signal analyzer 20, to which intensity signals of the reflected beam received by the photo detector of the optical pick-up 19 are inputted, is connected to the optical pick-up 19.

The signal analyzer 20 extracts error signals from the reflected beam received by the optical pick-up 19 and sends the error signals to a velocity controller 24, which servo-controls rotation of a spindle motor 22, movement of the optical pick-up 19 and tracking and focusing an object lens of the optical pick-up 19.

Further, the signal analyzer 20 analyzes light intensity of the reflected beam while writing data and reads address data therefrom. By reading the address data, a present data writing part of the optical disk 10, at which the optical pick-up 19 is writing data, can be known. The signal analyzer 20 sends the present address, at which the optical pick-up 19 is writing data, to the velocity controller 24 as address signals.

The velocity controller 24 controls the rotation of the spindle motor 22, the movement of the optical pick-up 19, etc. by the zone CLV manner so as to control the data writing velocity.

In the present embodiment, the velocity controller 24 knows the present address of the disk 10, at which the optical pick-up 19 is writing data, on the basis of the address signals. When the optical pick-up 19 reaches a prescribed address, the velocity controller 24 controls the rotation of the spindle motor 22, the movement of the optical pick-up 19, etc. so as to accelerate the data writing liner velocity.

The velocity controller 24 servo-controls the rotation of the spindle motor 22, the movement of the optical pick-up 19, etc. on the basis of the error signals extracted from the reflected beam by the signal analyzer 20.

The velocity controller 24 sends velocity control signals, which correspond to the present data writing liner velocity, to an indicator controller 25, which controls the LEDs 15 of the indicator 14.

In the present embodiment, the indicator 14 includes the LEDs 15 as well as the indicator 54 of the conventional disk player 50 (see FIG. 5). Namely, the lighting states of the LEDs 15 show the present data writing liner velocity. Note that, the indicator 14 acts as the means for indicating a change of data writing velocity and the means for indicating the changed liner velocity.

When the data writing liner velocity is accelerated by stages under the zone CLV manner, the indicator controller 25 controls the indicator 14 so as to inform the change of the liner velocity and the present liner velocity to the user.

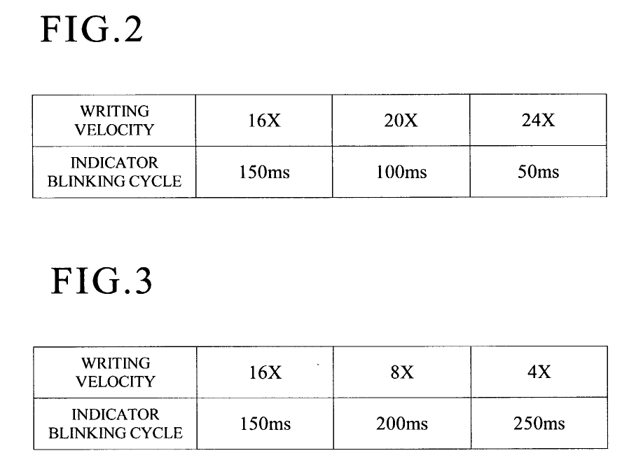

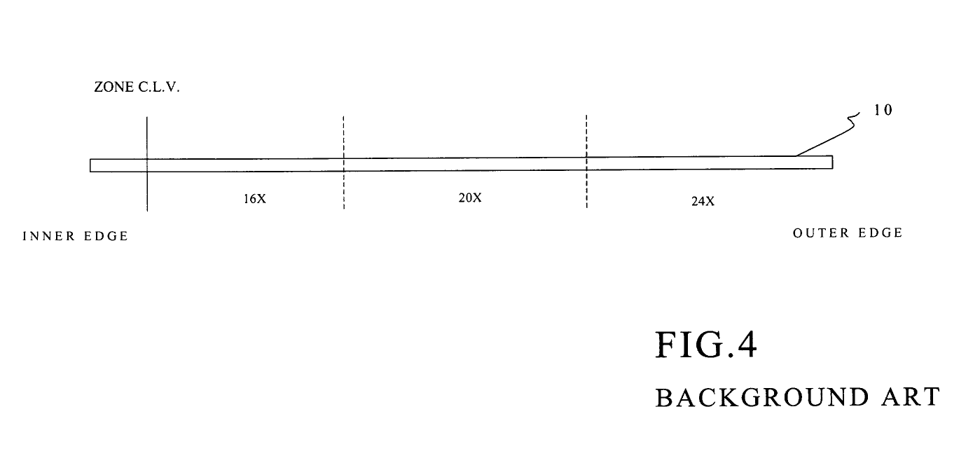

The action of the indicator controller 25 will be explained. As shown in FIG. 2, the indicator controller 25 varies blinking cycle time of the indicator 14 on the basis of the velocity control signals sent from the velocity controller 24.

While writing data with 16× velocity, the indicator controller 25 blinks the orange-colored light with the cycle time of 150 millisecond.

When the velocity controller 24 changes the liner velocity to 20× velocity, the indicator controller 25 blinks the orange-colored light with the cycle time of 100 millisecond.

When the velocity controller 24 changes the liner velocity to 24× velocity, the indicator controller 25 blinks the orange-colored light with the cycle time of 50 millisecond.

By changing the cycle time of blinking the indicator 14, the user can easily know the change of the data writing liner velocity and the present data writing liner velocity.

In the present embodiment, the data writing velocity is controlled by the zone CLV manner. But, the present invention is not limited to the zone CLV manner.

For example, in the case of writing data on a scratched or flexed optical disk, the optical disk player automatically makes the writing velocity slower than the predetermined velocity so as to securely write data. Namely, in the case that writing errors frequently occur, even if the user has previously assigned 16× velocity as the writing velocity, the optical disk player automatically changes the velocity to 8× or 4× velocity. This action will be explained with reference to FIG. 3.

While writing data with 16× velocity, the indicator controller usually controls the indicator 14 to blink the orange-colored light with the cycle time of 150 millisecond. If writing errors frequently occur while writing with 16× velocity, the velocity controller 24 changes the liner velocity to 8× velocity.

When the velocity controller 24 changes the liner velocity to 8× velocity, the indicator controller 25 blinks the orange-colored light with the cycle time of 200 millisecond.

When the velocity controller 24 further changes the liner velocity to 4× velocity, the indicator controller 25 blinks the orange-colored light with the cycle time of 250 millisecond.

Note that, the color and the cycle time of blinking the indicator 14 is not limited to the above described examples. Further, a plurality of indicators may be employed.

In the above described embodiment, the user can know the change of the liner velocity and the present liner velocity by blinking the indicator 14.

Other means for indicating the present writing velocity may be employed with or instead of the indicator 14. In another embodiment, a velocity indicator 17 (see FIG. 1) may be provided to the front panel of the optical disk player 30. For example, an LCD (Liquid Crystal Display) unit, which is capable of indicating the present writing velocity by characters and/or marks, may be employed as the velocity indicator 17. In this case, the user directly and easily know the present writing velocity.

The present invention may be applied to an optical disk player in which the data writing velocity is controlled by a CAV (Constant Angular Velocity) manner or a zone CAV manner.

In the CAV manner, data writing angular velocity is maintained throughout the optical disk.

In the zone CAV manner, the optical disk is divided into a plurality of zones from an inner part to an outer part. The writing angular velocity is changed in the zones respectively, but it is maintained or fixed in each zone.

Namely, the present invention may be applied to the optical disk players employing the CLV manner and the CAV manner.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. An optical disk player, comprising:
means for indicating a change of data writing velocity.

2. The optical disk player according to claim 1,
wherein said indicating means includes light emitting means which indicates the change of data writing velocity by changing a cycle time of blinking light.

3. An optical disk player, in which liner velocity of writing data is accelerated, by stages, toward an outer edge of an optical disk, comprising:
means for indicating a change of the liner velocity.

4. The optical disk player according to claim 3,
wherein said indicating means includes light emitting means which indicates the change of the liner velocity by changing a cycle time of blinking light.

5. The optical disk player according to claim 3, further comprising:
means for indicating the changed liner velocity.

6. The optical disk player according to claim 5,
wherein said indicating means includes light emitting means which indicates the changed liner velocity by changing a cycle time of blinking light.
